(19) United States
(12) Patent Application Publication
(10) Pub. No.: US 2017/0243221 A1
(43) Pub. Date: Aug. 24, 2017

(54) ONLINE PAYMENT TRANSACTION FRAUD DETECTION UTILIZING DELIVERY INFORMATION

(71) Applicant: MasterCard International Incorporated, Purchase, NY (US)

(72) Inventors: Lisa-Marie Gill, Tannersville, PA (US); Claire Le Gal, New York, NY (US); Gregory S. Phillips, St Louis, MO (US)

(21) Appl. No.: 15/047,070

(22) Filed: Feb. 18, 2016

(51) Int. Cl. G06Q 20/40

(52) U.S. Cl. CPC G06Q 20/4016

(57) ABSTRACT

According to some embodiments, a payment system authorization platform may receive an electronic payment transaction authorization request for an online purchase using a payment account, wherein the payment transaction authorization request includes delivery information. The payment system authorization platform may then automatically analyze data associated with the payment transaction authorization request, including the delivery information, in accordance with a fraud detection model to generate an authorization result. The payment system authorization platform may then transmit a response to the payment transaction authorization request including the authorization result.

### FIELD OF THE INVENTION

Embodiments disclosed herein relate to methods, apparatus and systems that facilitate online payment transaction fraud detection utilizing delivery information.

### BACKGROUND

Payment transaction systems are in widespread use. A prominent payment card system is operated by the assignee hereof, MasterCard International Incorporated, and by its member financial institutions. FIG. 1 schematically illustrates a typical transaction, as carried out by using a conventional payment system 100. To initiate the transaction, a customer may visit online web store or smartphone application operated by a merchant, selects goods that he/she wishes to purchase, and authorize that his or her payment account may be used to make the purchase. The merchant may then send an authorization request to an acquirer platform 110 associated with a financial institution with which the merchant has a relationship. The authorization request typically includes a payment card account number, the amount of the transaction and other information, such as merchant identification and location. Because a payment card was not physically given to the merchant in connection with the purchase, such transactions may be classified as Card Not Present (“CNP”) transactions. The authorization request message is routed via a payment system authorization platform 120 (which may be, for example, the well-known Banknet™ system operated by MasterCard International Incorporated) to an issuer platform 130 of the issuer financial institution that issued the customer's payment card.

Assuming that all is in order, the issuer platform 130 transmits a favorable authorization response to the acquirer platform 110 through the payment system authorization platform 120. The transaction is then completed and the product might be mailed to the customer digitally downloaded to a device associated with the customer (e.g., his or her tablet computer). A subsequent clearing transaction initiated by the merchant results in a transfer of the transaction amount from the customer's payment card account to an account that belongs to the merchant. The customer's payment card account may be, for example, a debit card account or a credit card account. In the former case, the clearing transaction results in the funds being debited directly from the account. In the latter case, the clearing transaction results in a charge being posted against the account, and the charge subsequently appears on the customer's monthly credit card statement.

The foregoing description of the typical transaction may be considered to be somewhat simplified in some respects. For example, a merchant processing system (not shown) may be interposed between a web server and the acquirer platform 110. As is familiar to those who are skilled in the art, a merchant processing system may be operated by or on behalf of the merchant to form part of the communications path between the acquirer platform 110 and a considerable number web servers operated by the merchant. It is also often the case that a third party transaction processing service, such as a Payment Services Provider (“PSP”), may operate to handle payment card transactions on behalf of the acquirer and on behalf of a large number of other parties (e.g., financial institutions).

The payment cardholder, acquirer and issuer financial institutions, and payment system authorization platforms all have an interest in reducing fraudulent transactions. Moreover, it is desirable to reduce fraudulent transactions without declining transactions that are, in fact, not fraudulent.

While approved authorizations drive revenue opportunity for card issuers, note that there are negative revenue impacts resulting from improper authorization declines. For example, it is not uncommon to hear cardholders complain about being declined when they are doing something they do all the time (e.g., purchasing groceries from his or her local supermarket).

The present inventors have recognized that there is a need for methods and/or systems to provide fraud detection model to facilitate the accurate and secure processing of online payment transactions.

### BRIEF DESCRIPTION OF THE DRAWINGS

FIG. 1 illustrates a typical payment card system.

FIG. 2 is a block diagram view of a system in accordance with some embodiments.

FIG. 3 is a fraud detection method that may be performed in accordance with some embodiments.

FIG. 4 is fraud detection method for different types of delivery methods that may be performed in accordance with some embodiments.

FIGS. 5, 6A, and 6B illustrate transaction flows according to some embodiments.

FIG. 7 represents a fraud detection model in accordance with some embodiments.

FIG. 8 is a payment system authorization platform that may be provided in accordance with some embodiments.

FIG. 9 is a transaction database that may be provided in accordance with some embodiments.

FIG. 10 is a fraud detection platform that may be provided in accordance with some embodiments.

FIG. 11 is a transaction result database that may be provided in accordance with some embodiments.

FIG. 12 is a high level block diagram of a decision management profiling system according to some embodiments.

FIG. 13 is an example of how information might be added as new data elements in an authorization request message according to some embodiments.

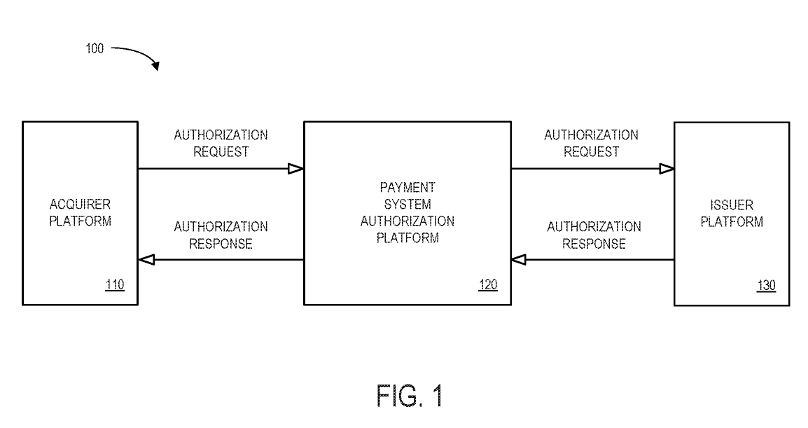

### DETAILED DESCRIPTION

In general, and for the purpose of introducing concepts of embodiments of the present invention, a payment account, such as an account associated with a “payment card” may be used to process transactions. As used herein, the phrase “payment card” might refer to, for example, a credit card, a debit card, a loyalty program card, a badge, a license, a passport card, a radio frequency apparatus, a smartphone, and/or a contactless card.

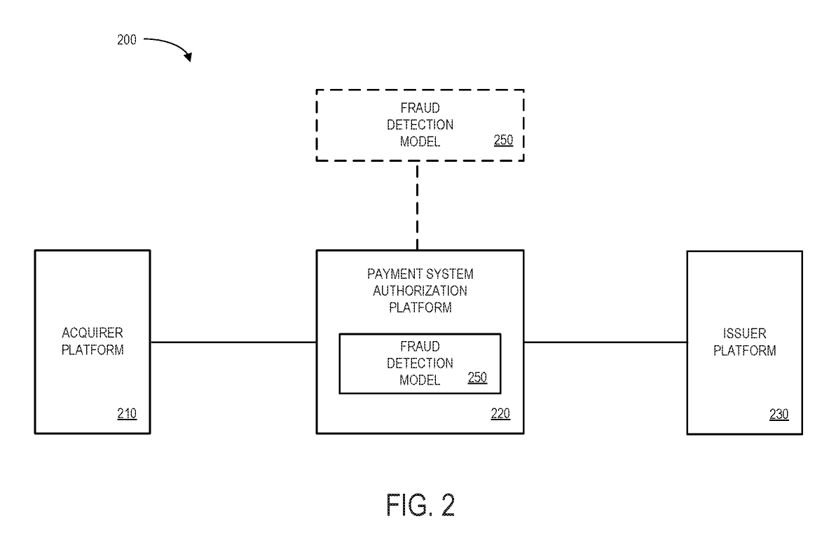

FIG. 2 is a block diagram of a transaction handling system 200 including components configured to operate in accordance with aspects of the processes described herein. It should be understood that the various components shown in FIG. 2 may be a subset of a larger system for providing payment card transactions for consumers and for facilitating purchase transactions between consumers and online merchants via credit card accounts, debit card accounts, reward card accounts, other types of financial accounts and the like, and/or for facilitating payment transactions between one or more financial institutions such as acquirer and issuer banks.

As before, an acquirer platform 210 may request authorization of a payment card transaction from an issuer platform 230 via a payment system authorization platform 220. In accordance with some embodiments, the requested authorization may include “delivery information.” For example, the delivery information might include an indication that a product is being mailed to an address other than the billing address associated with an account, an indication that a virtual delivery of a product is being downloaded to a new device identifier, etc. To reduce fraudulent transactions, the payment system authorization platform 220 may have incorporated therein—or exchange information with (as illustrated by dashed lines in FIG. 2)—a fraud detection model 250 that takes into account such delivery information in accordance with any of the embodiments described herein. Note that any of the embodiments described herein might be associated with either an internal or external fraud detection model 250.

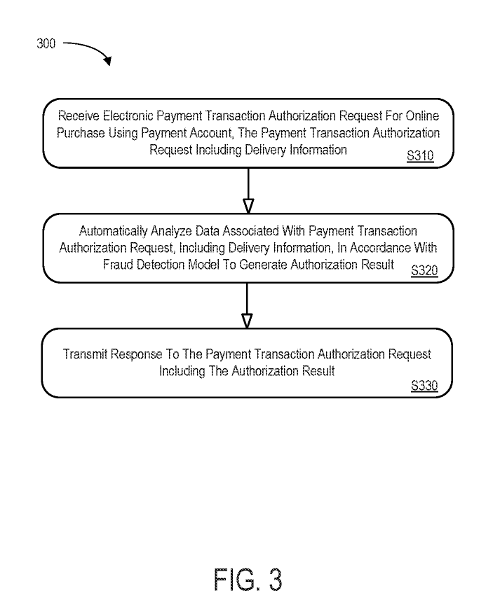

For example, FIG. 3 illustrates a method 300 that might be performed by payment system authorization platform 220 of the system 200 described with respect to FIG. 2 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein. Further note that some or all of the steps may be “automated.” As used herein, the term “automated” may refer to, for example, actions that can be performed with little or no human intervention.

At S310, a computer processor of a payment system authorization platform may receive an electronic payment transaction authorization request for an online purchase using a payment account, and the payment transaction authorization request may include delivery information. The payment account authorization request may be, for example, received from an acquirer platform and the payment account may be associated with a credit card account, a debit card account, a bank account, and/or a pre-paid stored value account. Note that any of the embodiments described herein might be practiced by a credit card company, an issuer, or any other party.

According to some embodiments, the delivery information received at S310 includes a delivery indicator. The delivery indicator may be, for example, associated with a billing address of the payment account, a physical ship-to-address for the online purchase (e.g., a postal address, ZIP code, latitude and longitude, etc.), an indication associated with how long a physical ship-to-address has been associated with the payment account (e.g., an address that has been provided for the first time within the last 30 days), and/or a gift indication (e.g., which might explain why a product is being delivered to a different address). In some embodiments, the delivery indicator is associated with a ship-to-store indication (e.g., indicating whether or not the store located within 20 miles of a cardholder's home address).

Instead of a physical address, some embodiments may be associated with a virtual or digital transaction indication (e.g., associated with a software purchase, in-game transaction, media rental, etc.). For example, the delivery indicator might be associated with a virtual address for the online purchase, a device identifier, an Internet Protocol (“IP”) address, and/or a communication address (e.g., an email address, telephone number, etc.). According to some embodiments, the delivery indicator may be associated with a travel ticket indication (e.g., an airline or train ticket). According to still other embodiments, the delivery indicator may be associated with an express delivery indication (e.g., an online order using overnight delivery might be more likely to be associated with a fraudulent transaction).

In addition to a delivery indication, according to some embodiments the delivery information further includes supplemental delivery data, such as a billing address of the payment account, a physical ship-to-address for the online purchase, a physical ship-to-store address, a virtual address for the online purchase, a device identifier, an IP address, a communication address, a travel date, a travel destination (e.g., some travel destinations might be more highly associated with fraudulent transactions), and/or an indication of a one-way travel ticket.

At S320, the computer processor of the payment system authorization platform may automatically analyze data associated with the payment transaction authorization request, including the delivery information, in accordance with a fraud detection model to generate an authorization result. The authorization result might comprise, for example, an indication as to whether or not the transaction is likely to be fraudulent. Note that the fraud detection model might also analyze information other than the delivery information to generate the result. For example, the fraud detection model might analyze a transaction amount, a transaction date, a transaction time, a cardholder profile, a merchant category, a product category, a cross border transaction, a domestic transaction, a retail shopper transaction, a travel spending transaction, an automotive fuel dispenser transaction, a game transaction, and/or a gambling transaction. According to some embodiments, the determination might be based at least in part on Bank Identification Number (“BIN”) and/or 16-digit primary account number associated with the authorization request. At S330, the processor of the payment system authorization platform may transmit a response to the payment transaction authorization request including the authorization result.

According to some embodiments, the system may supplement an authorization message with a reason code (e.g., alpha-numeric “A1”) which can then be interpreted by the customer (e.g., issuer, merchant) in some predefined manner (e.g., “A1” indicates that a product is going to be shipped to a relatively new address). A risk flag, risk score, and score data may all be supplemented into the authorization message. These items might be added by other services which could consume/reference the reason code to help generate a risk score, for example. According to some embodiments, score data may be associated with an application to monitor spending compliance (e.g., with governmental rules and regulations) and/or to combat fraud and misuse.

The supplemented authorization message may then be forwarded to at least one of: (i) the acquirer platform, and (ii) an issuer platform. For example, the issuer platform might use the supplemental data to further assess risk to help decide whether or not the transaction should be approved.

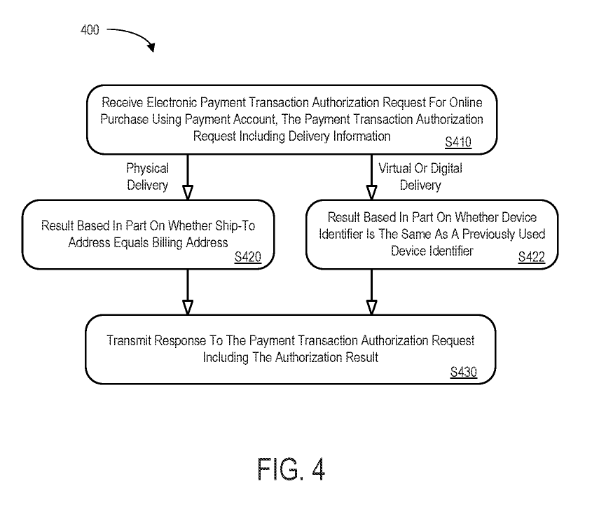

FIG. 4 is a fraud detection method for different types of delivery methods that may be performed in accordance with some embodiments.

At S410, an electronic payment transaction authorization request for an online purchase using a payment account may be received, and the payment transaction authorization request may include delivery information. The payment account authorization request may be, for example, received from an acquirer platform and the payment account may be associated with a credit card account, a debit card account, a bank account, and/or a pre-paid stored value account.

According to some embodiments, the delivery information received at S410 includes a delivery indicator of a physical shipping address (e.g., associated with a billing address of the payment account, a physical ship-to-address for the online purchase, an indication associated with how long a physical ship-to-address has been associated with the payment account, a gift indication, a ship-to-store indication, etc.). In the example of FIG. 4, it is determined whether a ship-to-address is the same as a billing address (decreasing the likelihood of fraud) at S420.

Instead of a physical address, some embodiments may be associated with a virtual or digital transaction indication (e.g., associated with a software purchase, in-game transaction, media rental, etc.). In the example of FIG. 4, it is determined whether a device identifier is the same as a previously used device identifier (decreasing the likelihood of fraud) at S422.

In both S420 and S422, a computer processor of the payment system authorization platform may automatically analyze data associated with the payment transaction authorization request, including the delivery information, in accordance with a fraud detection model to generate an authorization result. The authorization result might comprise, for example, an indication as to whether or not the transaction is likely to be fraudulent. Note that the fraud detection model might also analyze information other than the delivery information to generate the result. At S430, the processor of the payment system authorization platform may transmit a response to the payment transaction authorization request including the authorization result.

Note that a fraud detection model may analyze information about an authorization message (including delivery information) in accordance with at least one rule to generate a result. In addition to delivery information, the rule might be based on, for example, data about a cardholder associated with the authorization message, an account associated with the authorization message, a payment card associated with the authorization message, a merchant associated with the authorization message, and/or a merchant terminal associated with the authorization message.

According to some embodiments, the rule is based at least in part on a travel category. For example a cardholder might be classified as an international traveler, an interstate traveler, or someone who never travels. This information can then be used to flag unusual activity (e.g., a card associated with someone who rarely travels will be used to ship a product to a distant state or country).

According to some embodiments, the rules are based on an online spending category, whether or not the cardholder is a seasonal shopper, an established shopper, or someone who never shops online. Note that embodiments might review cardholder activity over a long enough time period to account for seasonal spending (e.g., Christmas, Valentine's Day, “Cyber Monday”), establish custom spend levels for different types of customers, allow a model to continually refresh threshold parameters, and/or manage authorization strategies to optimize approvals while balancing fraud risk.

Note that the rules may be based on information about a web server associated with the authorization message, such as (i) a transaction frequency, (ii) a transaction amount, and/or (iii) a transaction location. Further note that the rules may be based on issuers other than an issuer associated with the authorization message, a cardholder other than a cardholder associated with the authorization message, and/or a web server other than the web server associated with the authorization message. Note that that the rule may incorporate information from other issuers in addition to the issuer associated with the authorization message. In some embodiments, the rule(s) will not only be based on the issuer, cardholder, merchant, and web server associated with the authorization message, but also include information from other issuers, cardholders, merchants, and web servers not associated with the authorization message.

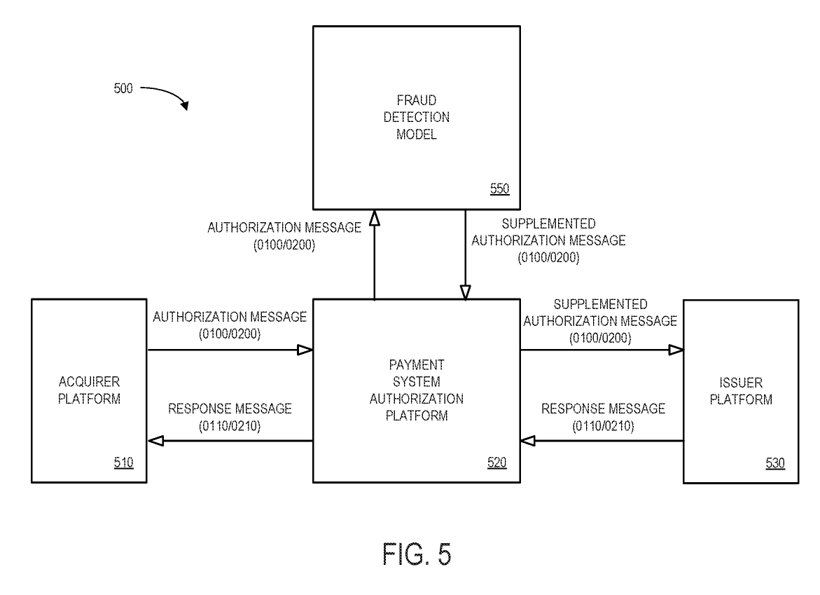

Responsive to the result, information about the authorization message may be transmitted to a payment system authorization platform. The information transmitted to the payment system authorization platform might comprise a supplemented authorization message. According to some embodiments, the supplemented authorization message might include a risk flag, a risk score, a cardholder category, a web server category, and/or enhanced score data. By way of example, consider FIG. 5 which illustrates an information flow 500 according to some embodiments. Initially, an acquirer platform 510 transmits an authorization message (e.g., an International Organization for Standardization (“ISO”) 0100/0200 message), including delivery information, to a payment system authorization platform 520. The payment system authorization platform 520 forwards the authorization message, including the delivery information, to a fraud detection model 550 which can analyze the message in accordance with one or more rules. For example, the fraud detection model 550 may determine that transaction is associated with unusual cardholder and a relatively new shipping address. This information may be dropped into the authorization message and a supplemental authorization message may be transmitted to the payment system authorization platform 520. The payment system authorization platform 520 forwards the supplemental authorization message to the issuer platform 530 which can use the augmented and enhanced data to determine whether to accept or decline the transaction (e.g., via an ISO 0110/0210 response message).

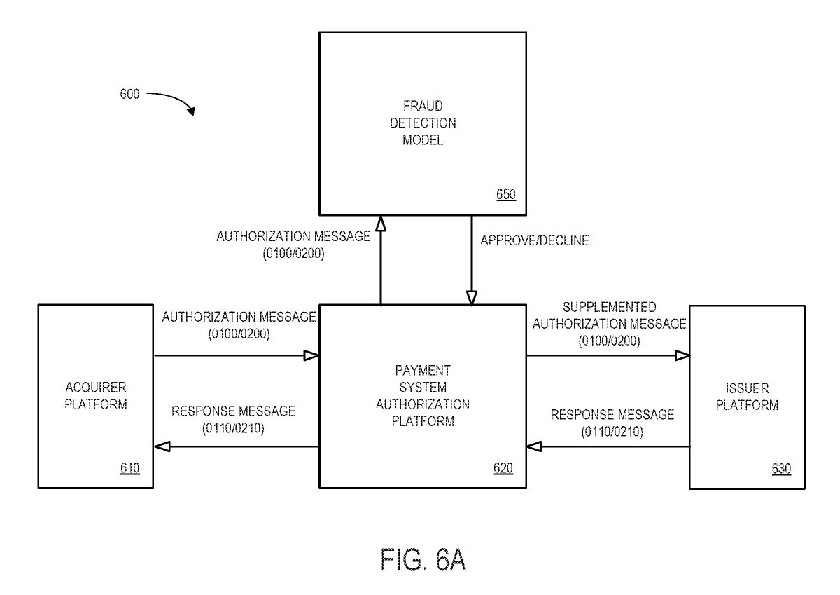

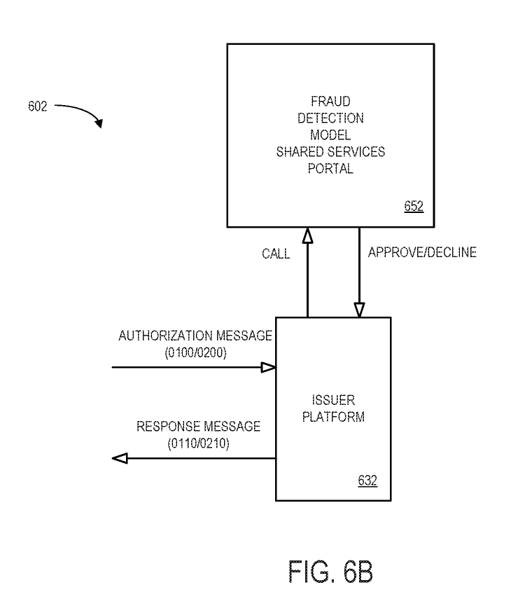

Instead of transmitting a supplemented authentication message to be used by the issuer platform 530, the fraud detection model 550 might instead make an initial approval (or decline) decision. By way of example, consider FIG. 6A which illustrates an information flow 600 according to such an embodiment. As before, an acquirer platform 610 transmits an authorization message (e.g., an ISO 0100/0200 message), including delivery information, to a payment system authorization platform 620. The payment system authorization platform 620 forwards the authorization message, including the delivery information, to a fraud detection model 650 which can analyze the message in accordance with one or more rules. For example, the fraud detection model 650 may determine that a particular transaction is associated with an online transaction involving a new device identifier. This information may be used by the fraud detection model 650 to decline the transaction (before the issuer platform 630 is involved). If the fraud detection model 650 instead approves the transaction, the payment system authorization platform 620 forwards the (standard or supplemental) authorization message to the issuer platform 630 which can determine whether to accept or decline the transaction (e.g., via an ISO 0110/0210 response message).

Consider a relatively high dollar, cross border, ecommerce authorization received from an electronics merchant via the acquirer platform 610 wherein a customer indicates that he or she will pick-up the electronics item from the merchant's store in another country. The payment system authorization platform 620 may route the authorization message to the fraud detection model 650. The fraud detection model 650 may perform a real-time lookup on the account to learn additional characteristic about the cardholder. In particular, it is determined that the cardholder never shops online or leaves the country. As a result the fraud detection model declines the transaction. According to some embodiments, further online authorizations are blocked for a pre-determined window of time (e.g., two hours).

As another example, consider FIG. 6B which illustrates an information flow 602 according to another embodiment. In this case, an issuer platform 632 calls a fraud detection model shared services portal 652 which can analyze a transaction request, including delivery information, in accordance with one or more rules. For example, the fraud detection model shared services portal 652 may determine that transaction is associated with unusual merchant activity and a never before used shipping address. This information may be used by the fraud detection model shared services portal 652 to decline the transaction (without involving a payment system authorization platform). If the fraud detection model shared services portal 652 instead provides a risk spectrum score, the issuer platform 632 may then use that score to determine whether to accept or decline the transaction (e.g., via an ISO 0110/0210 response message). According to some embodiments, the fraud detection model shared services portal 652 may consider risk data built from sources outside of a particular authorization message. Moreover, the fraud detection model shared services portal 652 may be associated with a fraud data mart that has access to fraud data rates for individual merchants and/or risk data determined based on information reported from other issuers.

Note that any of the fraud detection models described herein may be associated with a wide variety of risk parameters. For example, cardholder and/or network level profiling may integrate data insights into real-time authorization and fraud strategies. Moreover, behavioral insight may be focused on merchant-level data that views activities across multiple payment card types. Examples of merchant-level profiling considerations include retail/spend categories (e.g., automobile fuel, bookstore purchases, subscription services, etc.) and spend category classifications (e.g., department stores, electric appliance stores, gasoline stations, mail order purchases, etc.). The fraud detection model may also evaluate spending velocity parameters to look for transactions at an unusual volume at a particular time of day, unusual transaction amounts, and/or suspicious changes in approved and/or declined transaction volumes. According to some embodiments, historical ratios may be used to allow for variances across merchants or specific locations.

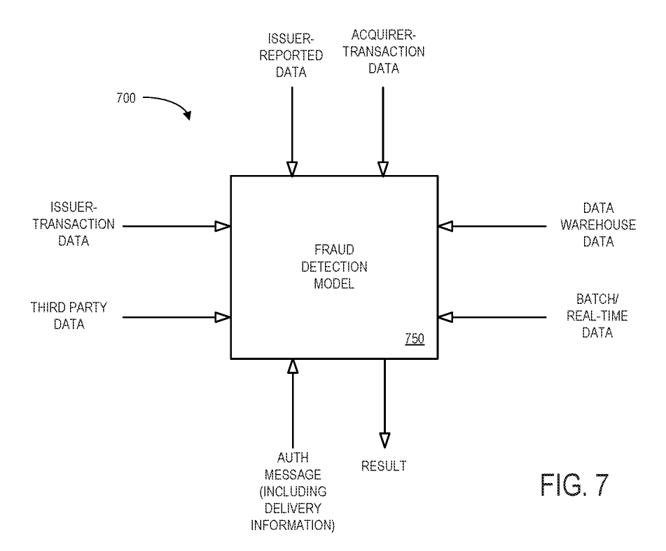

FIG. 7 illustrates a fraud detection model 750 according to some embodiments that may receive and utilize an authorization message (including delivery information), third party data, issuer transaction data, issuer reported data, acquirer transaction data, data warehouse data, and/or batched or real time data (which might be associated with any brand, single & dual messages) to generate a result to be applied to behavioral categories, portfolio diagnostics, market and competitive insights, and/or loyalty and rewards programs according to some embodiments.

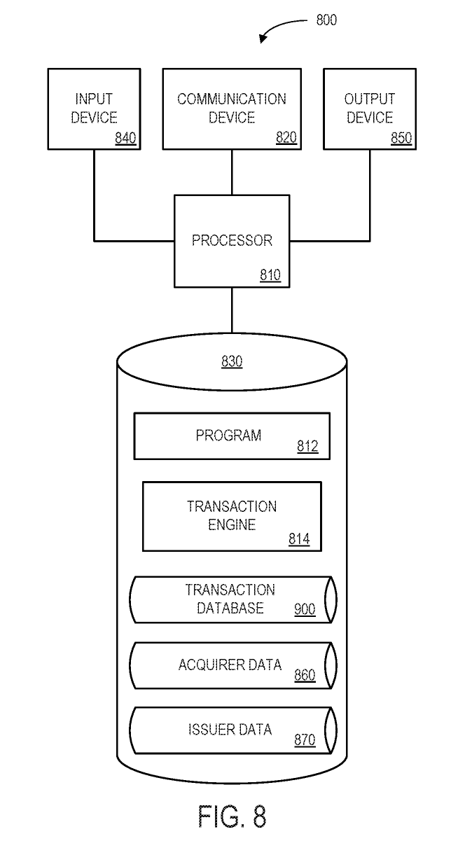

The embodiments described herein may be implemented using any number of different hardware configurations. For example, FIG. 8 illustrates a payment system authorization platform 800 that may be, for example, associated with the system 200 of FIG. 2. The payment system authorization platform 800 comprises a processor 810, such as one or more commercially available Central Processing Units (“CPUs”) in the form of one-chip microprocessors, coupled to a communication device 820 configured to communicate via a communication network (not shown in FIG. 8). The payment system authorization platform 800 further includes an input device 840 (e.g., a mouse and/or keyboard) and an output device 850 (e.g., a computer monitor).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or a transaction engine 814 for controlling the processor 810. The processor 810 performs instructions of the programs 812, 814, and thereby operates in accordance with any of the embodiments described herein. For example, the processor 810 may receive an electronic payment transaction authorization request for an online purchase using a payment account, wherein the payment transaction authorization request includes delivery information. The processor 810 may then communicate with a fraud detection model that will automatically analyze data associated with the payment transaction authorization request, including the delivery information, in accordance with a fraud detection model to generate an authorization result. The processor 810 may then transmit a response to the payment transaction authorization request including the authorization result.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

As used herein, information may be “received” by or “transmitted” to, for example: (i) the payment system authorization platform 800 from another device; or (ii) a software application or module within the payment system authorization platform 800 from another software application, module, or any other source.

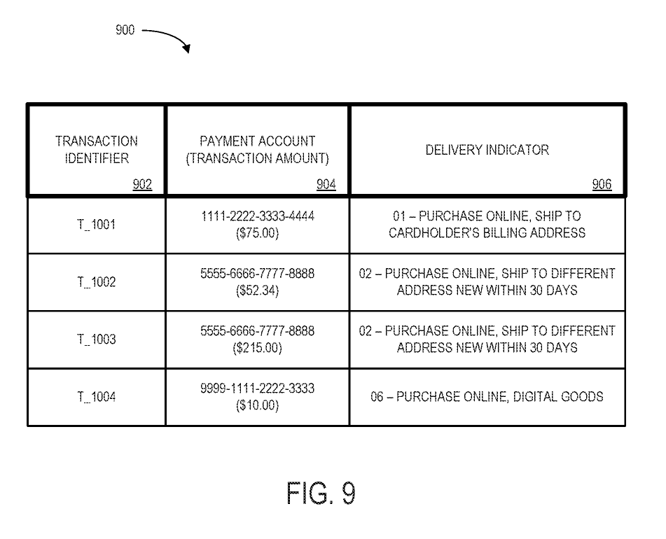

In some embodiments (such as shown in FIG. 8), the storage device 830 further stores a transaction database 900, acquirer data 860, and issuer data 870. An example of a database that may be used in connection with the payment system authorization platform 800 will now be described in detail with respect to FIG. 9. Note that the database described herein is only one example, and additional and/or different information may be stored therein. Moreover, various databases might be split or combined in accordance with any of the embodiments described herein.

Referring to FIG. 9, a table is shown that represents the transaction database 900 that may be stored at the payment system authorization platform 800 according to some embodiments. The table may include, for example, entries identifying payment card transactions. The table may also define fields 902, 904, 906 for each of the entries. The fields 902, 904, 906, may, according to some embodiments, specify: a transaction identifier 902, a payment account along with a transaction amount 904, and a delivery indicator 906. The transaction database 900 may be created and updated, for example, based on information received from an acquirer platform and/or a fraud model.

The transaction identifier 900 may be a unique alphanumeric code associated with an online transaction. The payment account along with the transaction amount 904 may indicate, for example, that the online transaction will charge $75.00 to a particular credit card number. The delivery indicator 906 might be, for example, a code describing how a product or service may be delivered to the cardholder. By way of example only, Table I defines some codes and associated descriptions that might be utilized:

TABLE I
Delivery Codes and Descriptions

| Code | Description |
|---|---|
| 01 | purchase online, ship to cardholder's billing address |
| 02 | purchase online, ship to new address (within 30 days) |
| | different than cardholder's billing address |
| 03 | purchase online, ship to new address (more than 30 days) |
| | different than cardholder's billing address |
| 04 | purchase online, ship to address different than cardholder's |
| | billing address as gift |
| 05 | purchase online, pick up in store |
| 06 | purchase online, digital good (includes online services) |
| 07 | purchase online, ticket purchases (including flights) |
| 08 | purchase online, ship to address in country outside |
| | cardholder's country |
| 09 | purchase online, ship to address different than cardholder's |
| | billing address using express or overnight delivery |
| 10 | Other (no other code applies) |

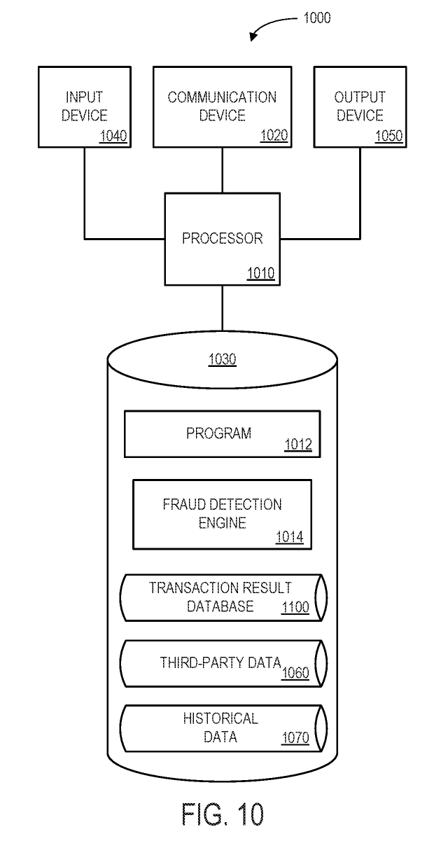

FIG. 10 illustrates a fraud detection model 1000 that may be, for example, associated with the system 200 of FIG. 2. The fraud detection model 1000 comprises a processor 1010, such as one or more commercially available CPUs in the form of one-chip microprocessors, coupled to a communication device 1020 configured to communicate via a communication network (not shown in FIG. 10). The fraud detection model 1000 further includes an input device 1040 (e.g., a mouse and/or keyboard) and an output device 1050 (e.g., a computer monitor).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1012 and/or a fraud detection engine 1014 for controlling the processor 1010. The processor 1010 performs instructions of the programs 1012, 1014, and thereby operates in accordance with any of the embodiments described herein. For example, the processor 1010 may analyze the information about the authorization message, including delivery information, in accordance with at least one rule to generate a result and transmit information about the authorization message to a payment system authorization platform, such as by transmitting a supplemented authorization message or an authorization approval decision.

The programs 1010, 1014 may be stored in a compressed, uncompiled and/or encrypted format. The programs 1010, 1014 may furthermore include other program elements, such as an operating system, a database management system, and/or device drivers used by the processor 1010 to interface with peripheral devices.

As used herein, information may be “received” by or “transmitted” to, for example: (i) the fraud detection model 1000 from another device; or (ii) a software application or module within the fraud detection model 1000 from another software application, module, or any other source.

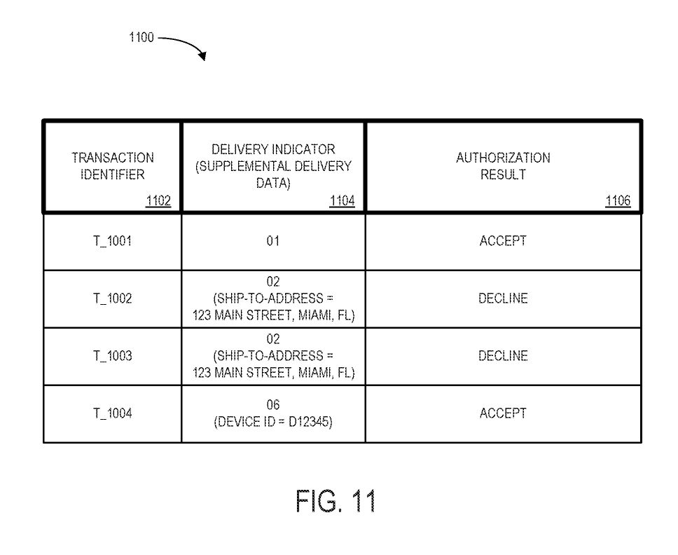

In some embodiments (such as shown in FIG. 10), the storage device 1030 further stores a transaction result database 1100, third party data 1060, and historical data 1070. An example of a database that may be used in connection with the fraud detection model 1000 will now be described in detail with respect to FIG. 11. Note that the database described herein is only one example, and additional and/or different information may be stored therein. Moreover, various databases might be split or combined in accordance with any of the embodiments described herein

Referring to FIG. 11, a table is shown that represents the transaction result database 1100 that may be stored at the payment system authorization platform 800 according to some embodiments. The table may include, for example, entries identifying payment card transactions. The table may also define fields 1102, 1104, 1106 for each of the entries. The fields 1102, 1104, 1106 may, according to some embodiments, specify: a transaction identifier 1102, a delivery indicator and supplemental delivery data 1104, and an authorization result 1106. The transaction database 1100 may be created and updated, for example, based on information received from an acquirer platform and/or a fraud detection model.

The transaction identifier 1102 may be a unique alphanumeric code associated with an online transaction and may be based on, or associated with the transaction identifier 902 in the transaction database 900. The delivery indicator 1104 may describe how a product or service will be provided in connection with the transaction and may, for example, use the codes described in connection with Table I herein described with respect to the delivery indicator 904 in the transaction database 900 (FIG. 9). The authorization result 1106 might, according to some embodiments, indicate that the transaction has been approved or declined by a fraud detection model.

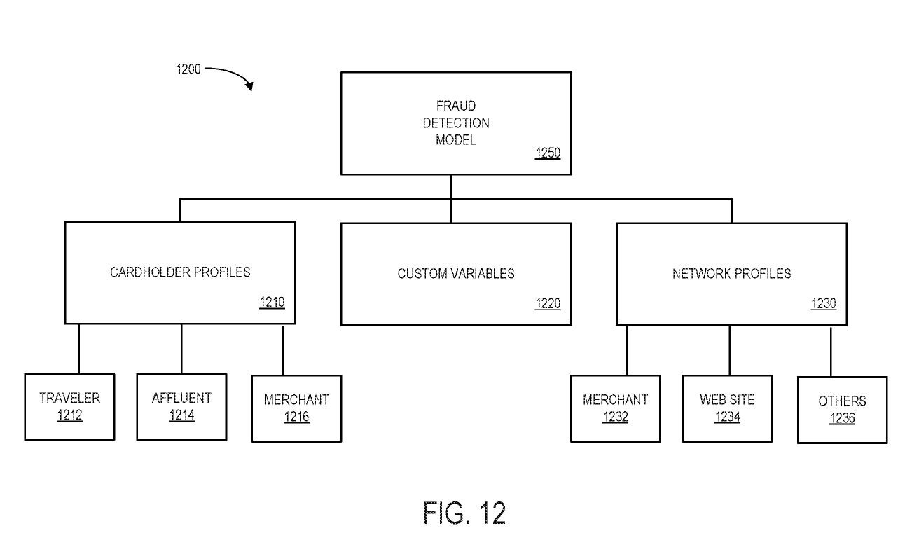

Any of the databases and/or analytic rules described herein may be used to integrate data insights into real-time authorization and/or fraud strategies. For example, FIG. 12 is a high level block diagram of a decision management profiling system 1200 according to some embodiments. A fraud detection model 1250 may access cardholder profiles 1212, which may include traveler information 1212, affluent cardholder information 1214, merchant information 1216 (e.g., retail stores from which he or she frequently picks up online purchases), and/or other data. Similarly, the fraud detection model 1250 may access customer variables 1220 (e.g., his or her billing address) and network profiles 1230, such as merchant information 1232, web site information, 1234, and/or other information 1236. In this way a fraud rule manager platform may leverage information to provide participating issuers with real-time supplemental data, within the online authorization, which can be consumed and interpreted by a receiving decisioning or rule platform to make more confident approval or decline decisions.

By providing issuers with real-time comparative data intelligence using both card-level data, delivery information, and POI web site level data, issuers may have a broader set of contextual information to better identify when it's safe to approve transactions that may have otherwise been declined before due to insufficient information.

The data intelligence associated with the fraud detection model 1250 may include card level data that a payment card system collects and analyzes, such as short and long term card spend activity on an issuer's portfolio, including, for example; geographic location, transaction type, spend category and amount level patterns. According to some embodiments, some or all of this comparative data may be provided in an online authorization message.

The data intelligence associated with the fraud detection model 1250 may also include network level data. For example, a payment card system may analyze global network information to provide real-time scores in an authorization message, including spend levels and shipping patterns as well as recent fraud rates at POI web sites.

For issuer accounts participating in a fraud detection model service, the fraud detection model 1250 may evaluate key data element values within a transaction and compare those data to the short and long term historical data points for that specific cardholder Primary Account Number (“PAN”) and a delivery address associated with the transaction. The results of those compares may be provided in the online message before forwarding it to the issuer or associated party.

According to some embodiments, the fraud detection model 1250 may populate contextual data points into the online message in real-time for transactions processed by the service. Each data value populated in the message may be coded to indicate to a receiving decisioning system, for example, valuable information relevant to that particular authorization request and can provide the issuer an improved level of confidence to appropriately approve or decline the transaction.

While some embodiments described herein may be implemented as a data service, note that authorization strategies might be driven by a number of different layered decisioning points that can help further enhance the insights provided. For example, an indicator that a particular transaction is associated with one of the best cardholders, performing an online transaction with a retailer he or she frequently uses to make in-store pickup purchases might be provided along with a transaction level fraud score indicating a low probability of fraud. This may help reduce the likelihood of a high spending cardholder having his or her card declined for a commonly performed low value purchase. Note that embodiments may be implemented to support all card products—consumer debit/credit, commercial credit/debit, prepaid, etc.

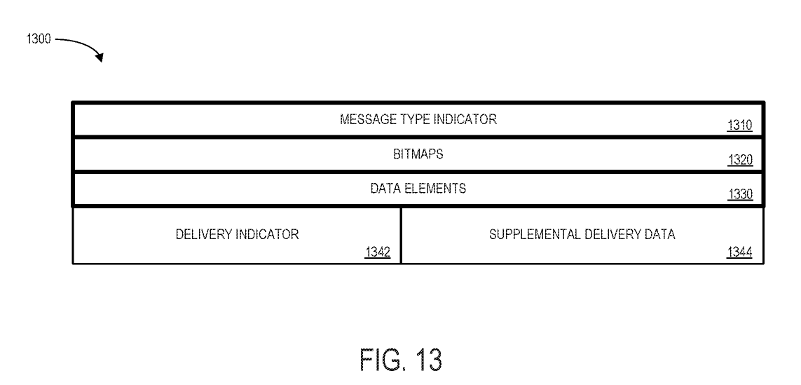

FIG. 13 is an example of how information might be added as new data element or fields in an authorization request message 1300 according to some embodiments. In particular, the message 1300 might be formatted in accordance with the ISO 8583 “Financial Transaction Card Originated Messages—Interchange Message” specification. The message 1300 might include a Message Type Indicator (“MTI”) 1310, such as a 4 digit numeric field which classifies the high level function of the message 1330. Bitmaps 1320 may include a field or subfield within the message 1300 which indicates which other data elements 1330 or data element subfields may be present elsewhere in a message 1300. Moreover, according to some embodiments, the message 1300 may include a delivery indicator 1342 (e.g., such as the codes described herein in connection with Table I) and supplemental delivery data 1344 (e.g., a physical address, device identifier, ticket destination, etc.).

Thus, embodiments may provide a substantially real-time fraud analytics platform that uses delivery information to help detect fraudulent online transactions.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method to facilitate online payment transaction fraud detection, comprising:
receiving, at a computer processor of a payment system authorization platform, an electronic payment transaction authorization request for an online purchase using a payment account, wherein the payment transaction authorization request includes delivery information;
automatically analyzing, by the computer processor of the payment system authorization platform, data associated with the payment transaction authorization request, including the delivery information, in accordance with a fraud detection model to generate an authorization result; and
transmitting, from the processor of the payment system authorization platform, a response to the payment transaction authorization request including the authorization result.

2. The method of claim 1, wherein the payment account authorization request is received from an acquirer platform and the payment account is associated with at least one of: (i) a credit card account, (ii) a debit card account, (iii) a bank account, and (iv) a pre-paid stored value account.

3. The method of claim 1, wherein the delivery information includes a delivery indicator.

4. The method of claim 3, wherein the delivery indicator is associated with at least one of: (i) a billing address of the payment account, (ii) a physical ship-to-address for the online purchase, (iii) an indication associated with how long a physical ship-to-address has been associated with the payment account, and (iv) a gift indication.

5. The method of claim 3, wherein the delivery indicator is associated with a ship-to-store indication.

6. The method of claim 3, wherein the delivery indictor is associated with a digital transaction indication.

7. The method of claim 6, wherein the delivery indicator is associated with at least one of: (i) a virtual address for the online purchase, (ii) a device identifier, (iii) an Internet protocol address, and (iv) a communication address.

8. The method of claim 3, wherein the delivery indicator is associated with a travel ticket indication.

9. The method of claim 3, wherein the delivery indicator is associated with an express delivery indication.

10. The method of claim 3, wherein the delivery information further includes supplemental delivery data.

11. The method of claim 10, wherein the supplemental delivery data comprises at least one of: (i) a billing address of the payment account, (ii) a physical ship-to-address for the online purchase, (iii) a physical ship-to-store address, (iv) a virtual address for the online purchase, (v) a device identifier, (vi) an Internet protocol address, (vii) a communication address, (viii) a travel date, (ix) a travel destination, and (x) an indication of a one-way travel ticket.

12. The method of claim 1, wherein the automatic analysis of data associated with the payment transaction authorization request by the fraud detection model to generate the authorization result is further based on at least one of: (i) a transaction amount, (ii) a transaction date, (iii) a transaction time, (iv) a cardholder profile, (v) a merchant category, (vi) a product category, (vii) a cross border transaction, (viii) a domestic transaction, (ix) a retail shopper transaction, (x) a travel spending transaction, (xi) an automotive fuel dispenser transaction, (xii) a game transaction, and (xiii) a gambling transaction.

13. A payment system authorization system to facilitate online payment transaction fraud detection, comprising:
a communication device to receive an electronic payment transaction authorization request for an online purchase using a payment account, wherein the payment transaction authorization request includes delivery information; and
a computer processor of the payment system authorization system programed to:
automatically analyze data associated with the payment transaction authorization request, including the delivery information, in accordance with a fraud detection model to generate an authorization result, and
transmit a response to the payment transaction authorization request including the authorization result.

14. The system of claim 13, wherein the payment account authorization request is received from an acquirer platform and the payment account is associated with at least one of: (i) a credit card account, (ii) a debit card account, (iii) a bank account, and (iv) a pre-paid stored value account.

15. The system of claim 13, wherein the delivery information includes a delivery indicator associated with at least one of: (i) a billing address of the payment account, (ii) a physical ship-to-address for the online purchase, (iii) an indication associated with how long a physical ship-to-address has been associated with the payment account, (iv) a gift indication, (v) a ship-to-store indication, (vi) a digital transaction indication, (vii) a virtual address for the online purchase, (viii) a device identifier, (ix) an Internet protocol address, (x) a communication address, (xi) a travel ticket indication, (xii) an express delivery indication.

16. The system of claim 15, wherein the delivery information further includes supplemental delivery data comprising at least one of: (i) a billing address of the payment account, (ii) a physical ship-to-address for the online purchase, (iii) a physical ship-to-store address, (iv) a virtual address for the online purchase, (v) a device identifier, (vi) an Internet protocol address, (vii) a communication address, (viii) a travel date, (ix) a travel destination, and (x) an indication of a one-way travel ticket.

17. The system of claim 13, wherein the automatic analysis of data associated with the payment transaction authorization request by the fraud detection model to generate the authorization result is further based on at least one of: (i) a transaction amount, (ii) a transaction date, (iii) a transaction time, (iv) a cardholder profile, (v) a merchant category, (vi) a product category, (vii) a cross border transaction, (viii) a domestic transaction, (ix) a retail shopper transaction, (x) a travel spending transaction, (xi) an automotive fuel dispenser transaction, (xii) a game transaction, and (xiii) a gambling transaction.

18. A non-transitory, computer readable medium having stored therein instructions that, upon execution, cause a computer to perform a method to facilitate online payment transaction fraud detection, the method comprising:
receiving an electronic payment transaction authorization request for an online purchase using a payment account, wherein the payment transaction authorization request includes delivery information;
automatically analyzing data associated with the payment transaction authorization request, including the delivery information, in accordance with a fraud detection model to generate an authorization result; and
transmitting a response to the payment transaction authorization request including the authorization result.

19. The medium of claim 18, wherein the payment account authorization request is received from an acquirer platform and the payment account is associated with at least one of: (i) a credit card account, (ii) a debit card account, (iii) a bank account, and (iv) a pre-paid stored value account.

20. The medium of claim 18, wherein the delivery information includes a delivery indicator associated with at least one of: (i) a billing address of the payment account, (ii) a physical ship-to-address for the online purchase, (iii) an indication associated with how long a physical ship-to-address has been associated with the payment account, (iv) a gift indication, (v) a ship-to-store indication, (vi) a digital transaction indication, (vii) a virtual address for the online purchase, (viii) a device identifier, (ix) an Internet protocol address, (x) a communication address, (xi) a travel ticket indication, (xii) an express delivery indication.

21. The medium of claim 20, wherein the delivery information further includes supplemental delivery data comprising at least one of: (i) a billing address of the payment account, (ii) a physical ship-to-address for the online purchase, (iii) a physical ship-to-store address, (iv) a virtual address for the online purchase, (v) a device identifier, (vi) an Internet protocol address, (vii) a communication address, (viii) a travel date, (ix) a travel destination, and (x) an indication of a one-way travel ticket.

22. The medium of claim 18, wherein the automatic analysis of data associated with the payment transaction authorization request by the fraud detection model to generate the authorization result is further based on at least one of: (i) a transaction amount, (ii) a transaction date, (iii) a transaction time, (iv) a cardholder profile, (v) a merchant category, (vi) a product category, (vii) a cross border transaction, (viii) a domestic transaction, (ix) a retail shopper transaction, (x) a travel spending transaction, (xi) an automotive fuel dispenser transaction, (xii) a game transaction, and (xiii) a gambling transaction.
